(19) United States
(12) Patent Application Publication
(10) Pub. No.: US 2019/0009187 A1
(43) Pub. Date: Jan. 10, 2019

(54) Distillation Column with Connected Reboiler

(71) Applicants: Larry Baxter, Orem, UT (US); Eric Mansfield, Spanish Fork, UT (US); Skyler Chamberlain, Provo, UT (US); Christopher Hoeger, Provo, UT (US)

(72) Inventors: Larry Baxter, Orem, UT (US); Eric Mansfield, Spanish Fork, UT (US); Skyler Chamberlain, Provo, UT (US); Christopher Hoeger, Provo, UT (US)

(21) Appl. No.: 15/641,738

(22) Filed: Jul. 5, 2017

(51) Int. Cl. B01D 3/32

(52) U.S. Cl. CPC B01D 3/322

(57) ABSTRACT

A method and device are disclosed for a distillation column. The distillation column comprises a first liquid portion below a first gas portion. The first liquid portion comprises an opening through a side wall comprising a gas backflow preventer. A horizontal reboiler is attached to the opening, the reboiler comprising a second gas portion above a second liquid portion. The recycle gas outlet and the recycle gas inlet are connected by a recycle gas pipe. A descending process liquid stream passes through a recycle gas stream in the first gas portion, forming a bottoms liquid stream, which pools and passes through the opening into the reboiler, and is separated in the reboiler into a product liquid stream, which passes out a liquid outlet, and the recycle gas stream, which is prevented from passing back through the opening by the gas backflow preventer, passing instead through a recycle gas outlet.

This invention was made with government support under DE-FE0028697 awarded by The Department of Energy. The government has certain rights in the invention.

### FIELD OF THE INVENTION

This invention relates generally to distillation processes. More particularly, we are interested in reboiler design and operation in the distillation process.

### BACKGROUND

Reboilers have been used in distillation since distillation has been practiced. Reboilers are used to provide heat to the bottom of distillation columns, boil a portion of the liquid from the bottom of the column and returning the vapors to the column, driving the distillation process. Reboilers, with associated equipment, take up a large footprint in an industrial plant, and can be susceptible to changes in liquid level. A reboiler system that is more compact and less susceptible to change in liquid level is needed.

U.S. Pat. No. 5,303,769, to Hoegberg, teaches an integrated thermosiphon heat exchanger apparatus. The present disclosure differs from this prior art disclosure in that the prior art heat exchanger is not connected to the opening in the side of the distillation column, but is connected to piping which connects to the distillation column. This disclosure is pertinent and may benefit from the devices and methods disclosed herein and is hereby incorporated for reference in its entirety for all that it teaches.

U.S. patent application number 20110107916, to Inoue, et al., teaches a system for recovering carbon dioxide from flue gas. The present disclosure differs from this prior art disclosure in that the prior art heat exchanger is not connected to the opening in the side of the regenerator, but is connected to piping which connects to the regenerator. This disclosure is pertinent and may benefit from the devices disclosed herein and is hereby incorporated for reference in its entirety for all that it teaches.

### SUMMARY

A method and device are disclosed for a distillation column. The distillation column comprises a first liquid portion below a first gas portion. The first gas portion comprises a recycle gas inlet. The first liquid portion comprises an opening through a side wall comprising a gas backflow preventer. A horizontal reboiler is attached to the opening, the reboiler comprising a second gas portion above a second liquid portion. The second gas portion comprises a recycle gas outlet and the second liquid portion comprises a liquid outlet. The recycle gas outlet and the recycle gas inlet are connected by a recycle gas pipe. A descending process liquid stream passes through a recycle gas stream in the first gas portion, forming a bottoms liquid stream. The bottoms liquid stream pools in the first liquid portion, passes through the opening into the reboiler, and is separated in the reboiler into a product liquid stream, which passes out the liquid outlet, and the recycle gas stream, which is prevented from passing back through the opening by the gas backflow preventer, passing instead through the recycle gas outlet.

The reboiler may comprise a heating element, a liquid outlet, and a gas outlet, the gas outlet extending from a top portion of the reboiler to a side of the distillation column, the liquid outlet being on a bottom portion of the reboiler. The liquid outlet may be situated opposite the opening.

A diameter of a connection between the distillation column and the reboiler may be substantially the same as an inner diameter of the reboiler.

Level detection may be provided by a differential pressure transmitter, level transmitter, or combinations thereof

The distillation column may comprise a plurality of trays above the first gas portion. The first liquid portion may be below all other portions of the distillation column.

The opening may comprise a flanged connection, a welded connection, or a threaded connection.

The process liquid stream may comprise water, hydrocarbons, organic solvents, ammonia, or combinations thereof.

The distillation column and the horizontal reboiler may comprise stainless steel, carbon steel, aluminum, ceramics, plastics, or combinations thereof.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIGS. 1A-B show isometric views of a bottom section of a distillation column with an attached reboiler.

FIG. 2 shows a side-view of a bottom section of a distillation column with an attached reboiler.

FIG. 3 shows a side-view of a bottom section of a distillation column with an attached reboiler.

FIG. 4 shows a side-view of a bottom section of a distillation column with an attached reboiler.

FIG. 5 shows a method for operating a distillation column with an attached reboiler.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention.

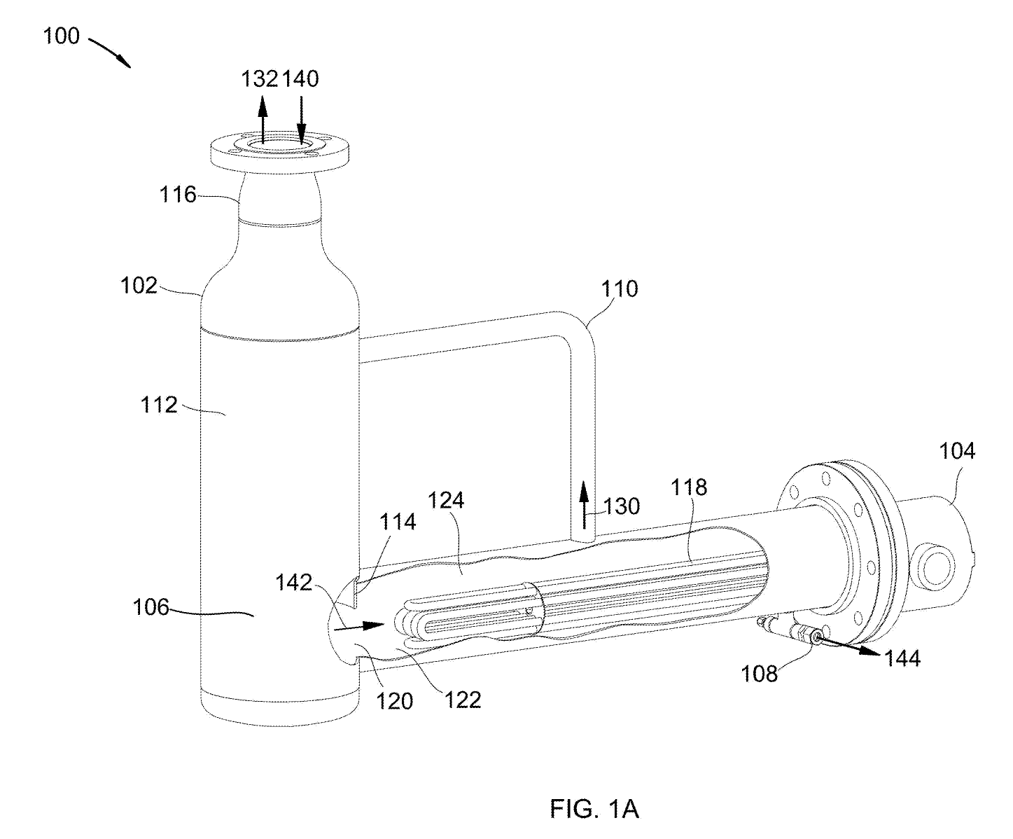

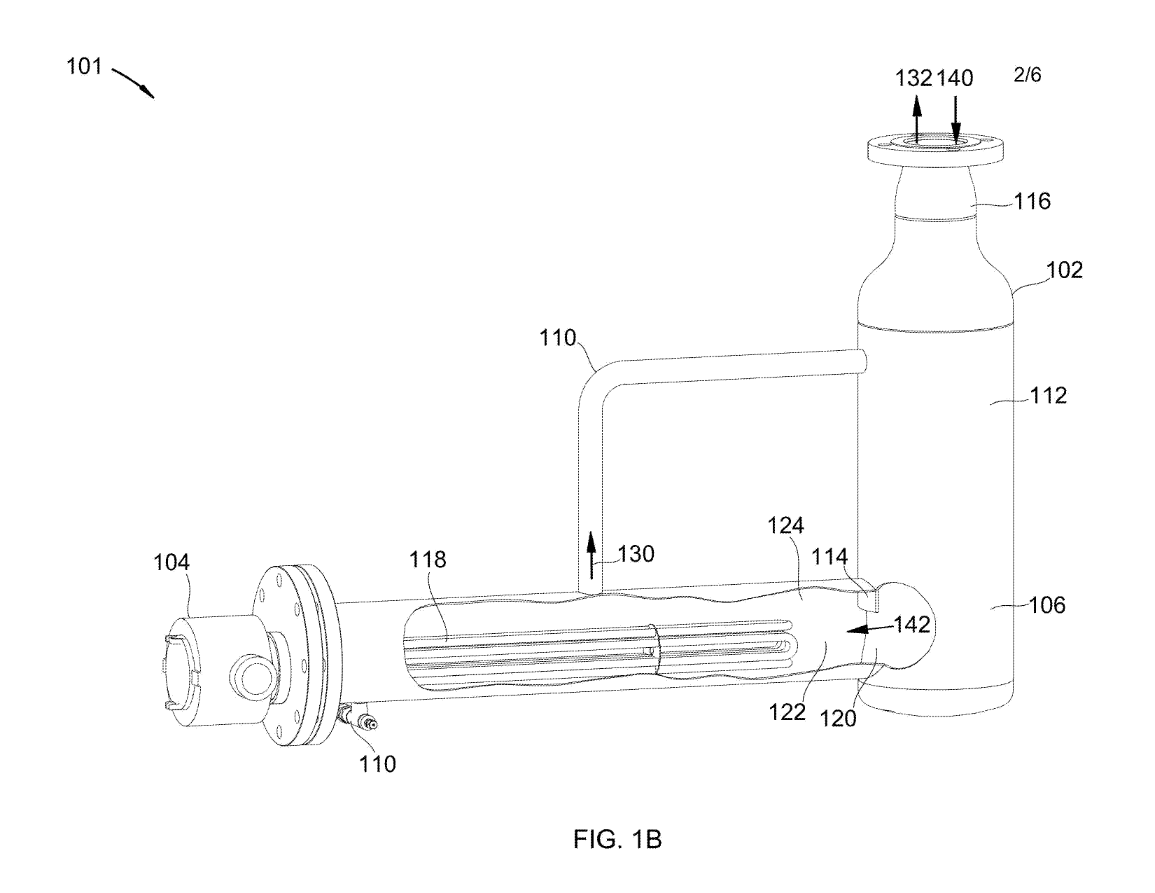

Referring to FIGS. 1A-B, isometric views of a bottom section of a distillation column with an attached reboiler are shown at 100 and 101, as per one embodiment of the present invention. Bottom section 102 of the distillation column comprises connection 116, first liquid portion 106, first gas portion 112, opening 120, and gas backflow preventer 114. Connection 116 connects bottom section 102 to the upper portion of the distillation column (not shown). Horizontal reboiler 104 connects to bottom section 102 through opening 120. Reboiler 104 comprises heating coils 118, liquid outlet 108, gas outlet 110, second liquid portion 122, and second gas portion 124. Gas outlet 110 connects second gas portion 124 with first gas portion 112. Opening 120 connects first liquid portion 106 with second liquid portion 122. Process liquid stream 140 descends from the upper portion through connection 116 into bottom section 102, pooling in first liquid portion 106, becoming bottoms liquid stream 142. Bottoms liquid stream 142 passes through opening 120 into second liquid portion 122 where it is heated, producing product liquid stream 144, which passes out of liquid outlet 108, and recycle gas stream 130, which ascends into second gas portion 124. Recycle gas stream 130 is prevented from backflowing into first liquid portion 106 by gas backflow preventer 114. Recycle gas stream 130 passes through gas outlet 110 and into first gas portion, where it ascends upwards past process liquid stream 140, leaving bottom section 102 as bottoms recycle gas stream 132.

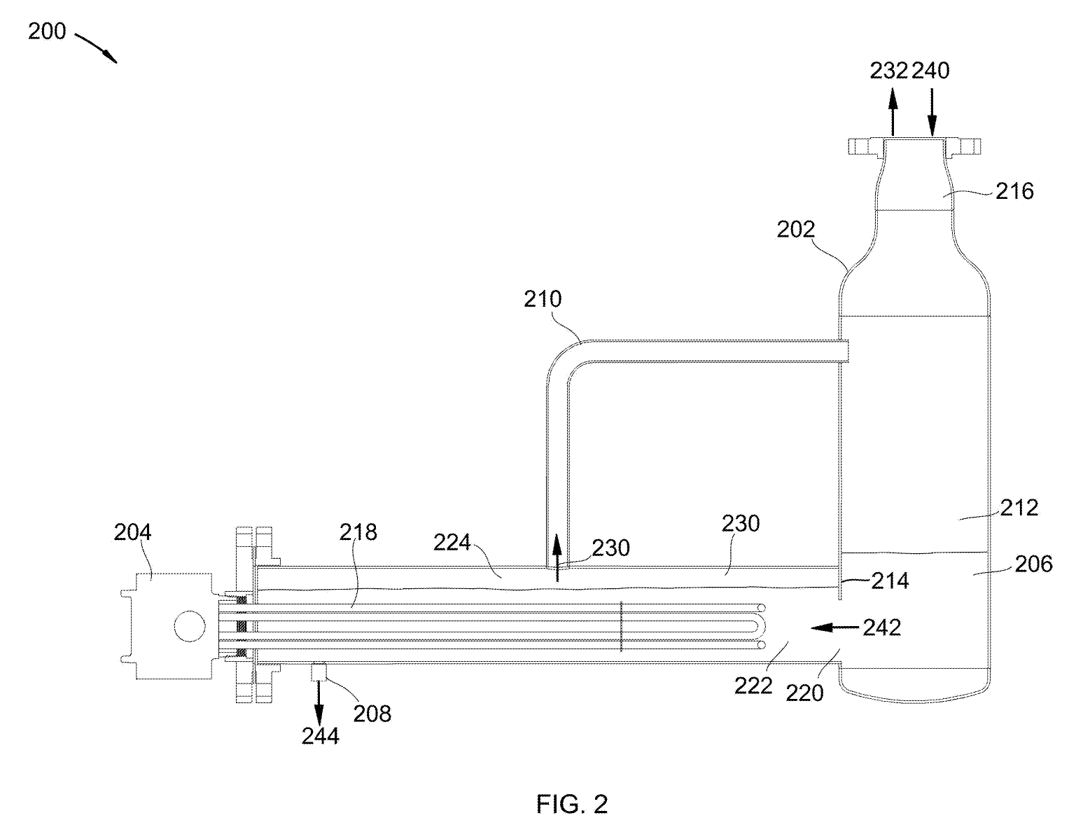

Referring to FIG. 2, a side-view of a bottom section of a distillation column with an attached reboiler is shown at 200, as per one embodiment of the present invention. Bottom section 202 of the distillation column comprises connection 216, first liquid portion 206, first gas portion 212, opening 220, and gas backflow preventer 214. Connection 216 connects bottom section 202 to the upper portion of the distillation column (not shown). Horizontal reboiler 204 connects to bottom section 202 through opening 220. Reboiler 204 comprises heating coils 218, liquid outlet 208, gas outlet 210, second liquid portion 222, and second gas portion 224. Gas outlet 210 connects second gas portion 224 with first gas portion 212. Opening 220 connects first liquid portion 206 with second liquid portion 222. Process liquid stream 240 descends from the upper portion through connection 216 into bottom section 202, pooling in first liquid portion 206, becoming bottoms liquid stream 242. Bottoms liquid stream 242 passes through opening 220 into second liquid portion 222 where it is heated, producing product liquid stream 244, which passes out of liquid outlet 208, and recycle gas stream 230, which ascends into second gas portion 224. Recycle gas stream 230 is prevented from backflowing into first liquid portion 206 by gas backflow preventer 214. Recycle gas stream 230 passes through gas outlet 210 and into first gas portion, where it ascends upwards past process liquid stream 240, leaving bottom section 202 as bottoms recycle gas stream 232.

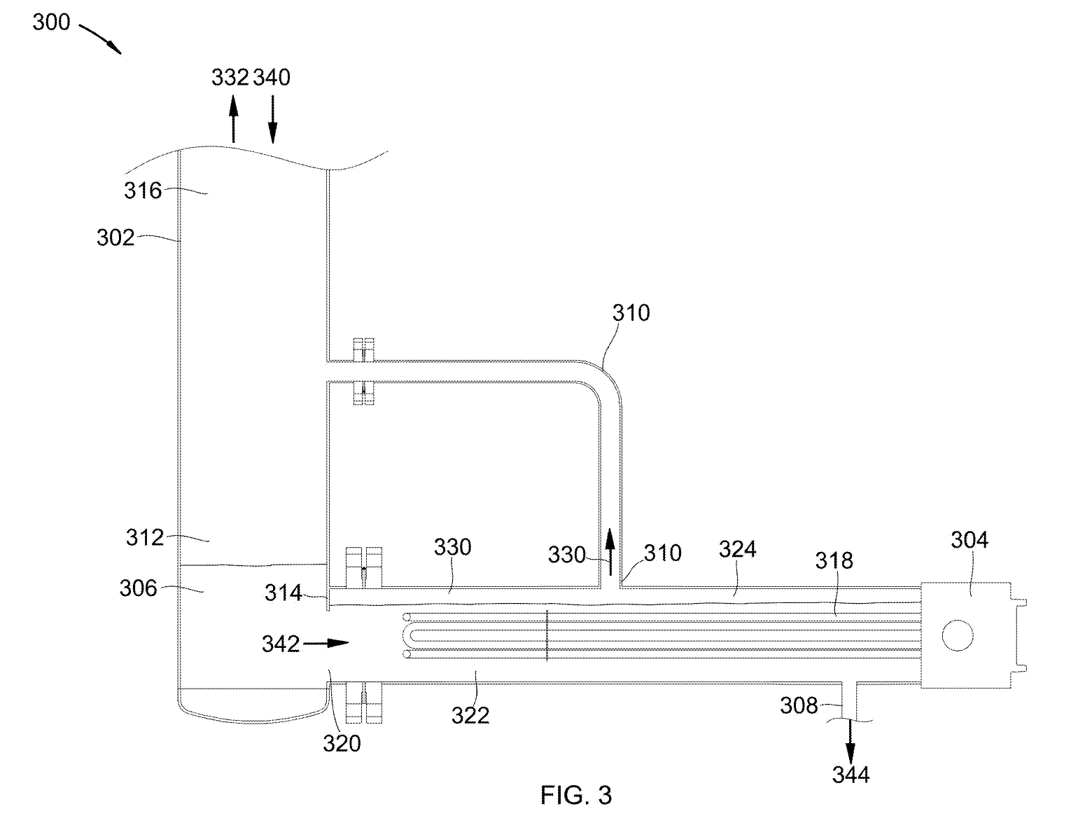

Referring to FIG. 3, a side-view of a bottom section of a distillation column with an attached reboiler is shown at 300, as per one embodiment of the present invention. Bottom section 302 of the distillation column comprises connection 316, first liquid portion 306, first gas portion 312, opening 320, and gas backflow preventer 314. Connection 316 connects bottom section 302 to the upper portion of the distillation column (not shown). Horizontal reboiler 304 connects to bottom section 302 through opening 320. Reboiler 304 comprises heating coils 318, liquid outlet 308, gas outlet 310, second liquid portion 322, and second gas portion 324. Gas outlet 310 connects second gas portion 324 with first gas portion 312. Opening 320 connects first liquid portion 306 with second liquid portion 322. Process liquid stream 340 descends from the upper portion through connection 316 into bottom section 302, pooling in first liquid portion 306, becoming bottoms liquid stream 342. Bottoms liquid stream 342 passes through opening 320 into second liquid portion 322 where it is heated, producing product liquid stream 344, which passes out of liquid outlet 308, and recycle gas stream 330, which ascends into second gas portion 324. Recycle gas stream 330 is prevented from backflowing into first liquid portion 306 by gas backflow preventer 314. Recycle gas stream 330 passes through gas outlet 310 and into first gas portion, where it ascends upwards past process liquid stream 340, leaving bottom section 302 as bottoms recycle gas stream 332.

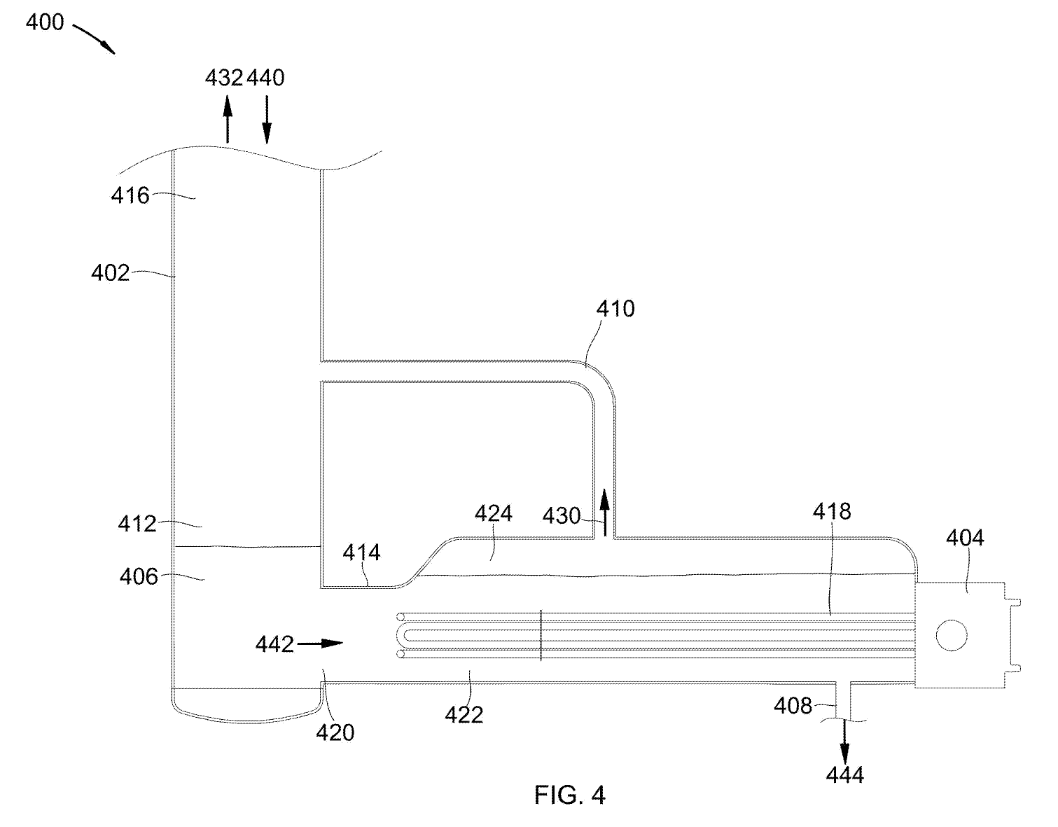

Referring to FIG. 4, a side-view of a bottom section of a distillation column with an attached reboiler is shown at 400, as per one embodiment of the present invention. Bottom section 402 of the distillation column comprises connection 416, first liquid portion 406, first gas portion 412, opening 420, and gas backflow preventer 414. Connection 416 connects bottom section 402 to the upper portion of the distillation column (not shown). Horizontal reboiler 404 connects to bottom section 402 through opening 420. Reboiler 404 comprises heating coils 418, liquid outlet 408, gas outlet 410, second liquid portion 422, and second gas portion 424. Gas outlet 410 connects second gas portion 424 with first gas portion 412. Opening 420 connects first liquid portion 406 with second liquid portion 422. Process liquid stream 440 descends from the upper portion through connection 416 into bottom section 402, pooling in first liquid portion 406, becoming bottoms liquid stream 442. Bottoms liquid stream 442 passes through opening 420 into second liquid portion 422 where it is heated, producing product liquid stream 444, which passes out of liquid outlet 408, and recycle gas stream 430, which ascends into second gas portion 424. Recycle gas stream 430 is prevented from backflowing into first liquid portion 406 by gas backflow preventer 414. Recycle gas stream 430 passes through gas outlet 410 and into first gas portion, where it ascends upwards past process liquid stream 440, leaving bottom section 402 as bottoms recycle gas stream 432.

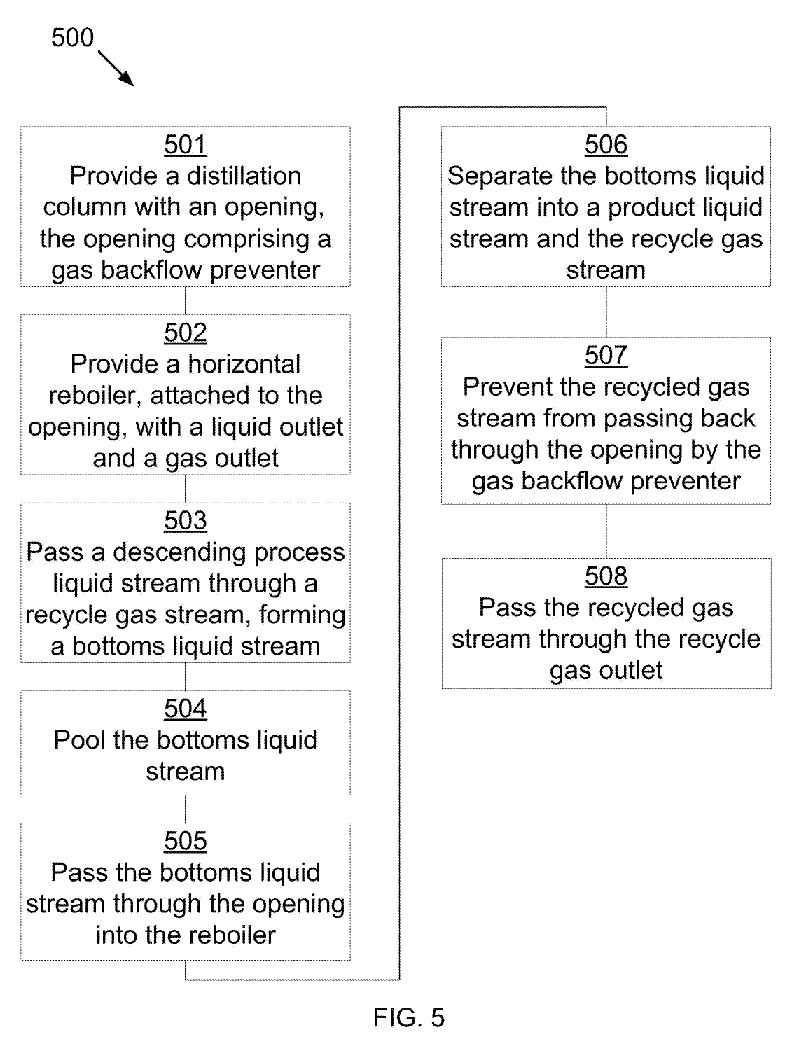

Referring to FIG. 5, a method for operating a distillation column with an attached reboiler is shown at 500, as per one embodiment of the present invention. A distillation column is provided, comprising a first liquid portion below a first gas portion, the first gas potion comprising a recycle gas inlet and the first liquid portion comprising an opening through a side wall comprising a gas backflow preventer 501. A horizontal reboiler is provided comprising a second gas portion above a second liquid portion attached to the opening, the second gas portion comprising a recycle gas outlet, the second liquid portion comprising a liquid outlet, and the recycle gas outlet and the recycle gas inlet being connected by a recycle gas pipe 502. A descending process liquid stream passes through a recycle gas stream in the first gas portion, forming a bottoms liquid stream 503. The bottoms liquid stream pools in the first liquid portion 504. The bottoms liquid stream passes through the opening into the reboiler 505. The bottoms liquid stream separates into a product liquid stream and the recycle gas stream 506. The product liquid stream passes out the liquid outlet. The recycled gas stream is prevented from passing back through the opening by the gas backflow preventer 507, passing instead through the recycle gas outlet 508.

In some embodiments, the reboiler comprises a heating element, a liquid outlet, and a gas outlet, the gas outlet extending from a top portion of the reboiler to a side of the distillation column, the liquid outlet being on a bottom portion of the reboiler. In some embodiments, the liquid outlet is situated opposite the opening.

In some embodiments, a diameter of a connection between the distillation column and the reboiler are substantially the same as an inner diameter of the reboiler.

In some embodiments, liquid level is detected by a differential pressure transmitter, level transmitter, or combinations thereof

In some embodiments, the distillation column comprises a plurality of trays above the first gas portion. In some embodiments, the first liquid portion is below all other portions of the distillation column.

In some embodiments, the opening comprises a flanged connection, a welded connection, or a threaded connection.

In some embodiments, the process liquid stream comprises water, hydrocarbons, organic solvents, ammonia, or combinations thereof.

In some embodiments, the distillation column and the horizontal reboiler comprise stainless steel, carbon steel, aluminum, ceramics, plastics, or combinations thereof

1. A device comprising:
a distillation column comprising a first liquid portion below a first gas portion;
the first gas portion comprising a recycle gas inlet;
the first liquid portion comprising an opening through a side wall comprising a gas backflow preventer;
a horizontal reboiler comprising a second gas portion above a second liquid portion, the horizontal reboiler attached to the opening;
the second gas portion comprising a recycle gas outlet and the second liquid portion comprising a liquid outlet;
the recycle gas outlet and the recycle gas inlet being connected by a recycle gas pipe;
the distillation column, wherein:
a descending process liquid stream passes through a recycle gas stream in the first gas portion, forming a bottoms liquid stream;
the bottoms liquid stream pools in the first liquid portion, passes through the opening into the reboiler, and is separated in the reboiler into a product liquid stream, which passes out the liquid outlet, and the recycle gas stream, which is prevented from passing back through the opening by the gas backflow preventer, passing instead through the recycle gas outlet.

2. The device of claim 1, the reboiler comprising a heating element, a liquid outlet, and a gas outlet, the gas outlet extending from a top portion of the reboiler to a side of the distillation column, the liquid outlet being on a bottom portion of the reboiler.

3. The device of claim 2, wherein the liquid outlet is situated opposite the opening.

4. The device of claim 1, wherein a diameter of a connection between the distillation column and the reboiler are substantially the same as an inner diameter of the reboiler.

5. The device of claim 1, further comprising level detection by a differential pressure transmitter, level transmitter, or combinations thereof

6. The device of claim 1, wherein the distillation column comprises a plurality of trays above the first gas portion.

7. The device of claim 6, wherein the first liquid portion is below all other portions of the distillation column.

8. The device of claim 1, wherein the opening comprises a flanged connection, a welded connection, or a threaded connection.

9. The device of claim 1, wherein the process liquid stream comprises water, hydrocarbons, organic solvents, ammonia, or combinations thereof.

10. The device of claim 1, wherein the distillation column and the horizontal reboiler comprise stainless steel, carbon steel, aluminum, ceramics, plastics, or combinations thereof

11. A method for operating a distillation column comprising:
providing a distillation column comprising a first liquid portion below a first gas portion, the first gas portion comprising a recycle gas inlet and the first liquid portion comprising an opening through a side wall comprising a gas backflow preventer;
providing a horizontal reboiler comprising a second gas portion above a second liquid portion attached to the opening, the second gas portion comprising a recycle gas outlet, the second liquid portion comprising a liquid outlet, and the recycle gas outlet and the recycle gas inlet being connected by a recycle gas pipe;
passing a descending process liquid stream through a recycle gas stream in the first gas portion, forming a bottoms liquid stream;
pooling the bottoms liquid stream in the first liquid portion;
passing the bottoms liquid stream through the opening into the reboiler;
separating the bottoms liquid stream into a product liquid stream, which passes out the liquid outlet, and the recycle gas stream, which is prevented from passing back through the opening by the gas backflow preventer, passing instead through the recycle gas outlet.

12. The method of claim 11, the reboiler comprising a heating element, a liquid outlet, and a gas outlet, the gas outlet extending from a top portion of the reboiler to a side of the distillation column, the liquid outlet being on a bottom portion of the reboiler.

13. The method of claim 12, wherein the liquid outlet is situated opposite the opening.

14. The method of claim 11, wherein a diameter of a connection between the distillation column and the reboiler are substantially the same as an inner diameter of the reboiler.

15. The method of claim 11, further comprising detecting level by a differential pressure transmitter, level transmitter, or combinations thereof

16. The method of claim 11, providing the distillation column comprising a plurality of trays above the first gas portion.

17. The method of claim 16, wherein the first liquid portion is below all other portions of the distillation column.

18. The method of claim 11, wherein the opening comprises a flanged connection, a welded connection, or a threaded connection.

19. The method of claim 11, providing the process liquid stream comprising water, hydrocarbons, organic solvents, ammonia, or combinations thereof

20. The method of claim 11, wherein the distillation column and the horizontal reboiler comprise stainless steel, carbon steel, aluminum, ceramics, plastics, or combinations thereof.
